(19) United States
(12) Patent Application Publication
(10) Pub. No.: US 2006/0291743 A1
(43) Pub. Date: Dec. 28, 2006

(54) Configurable motion compensation unit

(76) Inventors: Suketu Partiwala, Chandler, AZ (US); Kalpesh D. Mehta, Chandler, AZ (US)

Correspondence Address: BUCKLEY, MASCHOFF, TALWALKAR LLC, 5 ELM STREET, NEW CANAAN, CT, 06840, US

(21) Appl. No.: 11/165,979

(22) Filed: Jun. 24, 2005

(51) Int. Cl. G06K 9/40

(52) U.S. Cl. 382/268; 382/260

(57) ABSTRACT

According to some embodiments, a first filter receives input pixel information and provides a first output. A buffer stores the first output, and a second filter receives information from the buffer and provides output pixel information. Moreover, at least one of the first or second filters are configurable to support motion compensation for a plurality of video compression standards.

### BACKGROUND

Image information may be transmitted from a one device to another device via a communication network. For example, a sending device might transmit a digital video image to a remote television or Personal Computer (PC). Moreover, various encoding techniques may be used to reduce the bandwidth that is required to transmit the image information. For example, information about differences between a current picture and a previous picture might be transmitted. In this case, the receiving device may decode the information (e.g., by using the previous picture and the differences to generate the current picture) and provide the image to a viewer.

### BRIEF DESCRIPTION OF THE DRAWINGS

FIG. 1 is a block diagram of a digital video decoder according to some embodiments.

FIG. 2 illustrates motion compensation associated with vertical movement.

FIG. 3 illustrates motion compensation associated with horizontal movement.

FIG. 4 illustrates motion compensation associated with diagonal movement.

FIG. 5 is a flow chart of a method according to some embodiments.

FIG. 6 is a block diagram of a motion compensation unit according to some embodiments.

FIG. 7 is a block diagram of a system according to some embodiments.

### DETAILED DESCRIPTION

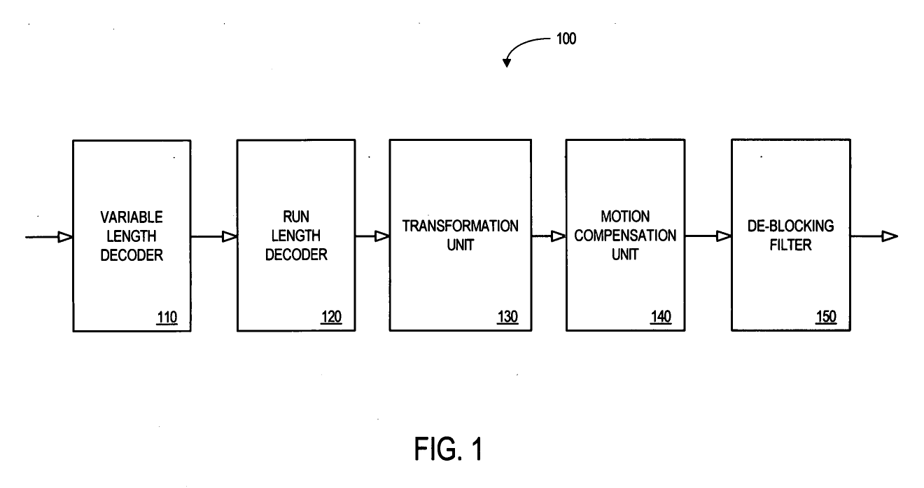

FIG. 1 is a block diagram of a digital video decoder 100 according to some embodiments. The decoder 100 might, for example, receive a compressed bit stream from a remote sending device. The decoder 100 may also receive a compressed bit stream from a local storage device, such as a Double Data Rate (DDR) Synchronous Dynamic Random Access Memory (SDRAM) unit, a hard disk drive, or removable storage media. The decoder 100 may be associated with a re-configurable architecture that uses micro-sequencers, processing elements, and/or hardware accelerators. One example of such a device is the INTEL® MxP5800 Digital Media Processor.

A variable length decoder 110 may receive the bit stream and generate packets, which are then converted into coefficient data by a run length decoder 120. A transformation unit 130 may then provide residue (or error information) associated with a picture element (“pel”) to a motion compensation unit 140. The transformation unit 130 might be associated with, for example, a discrete cosine transformation, an integer transformation, or any other transformation.

A motion compensation unit 140 may then generate the current frame using information about a previous frame along with information about differences between the previous frame and the current frame. That is, the motion compensation unit 140 may combine the residue information received from the transformation unit 130 with predicted information generated from interpolation to generate the final reconstructed pixel, including luminance and chrominance values associated with portions of a current picture (or “blocks” of the current image “frame”). For example, a motion vector may indicate how far a block has moved as compared to its previous location in the frame. In this case, the motion compensation unit 140 may use the location of the block in the previous frame along with the motion vector to calculate where the block should appear in the current frame.

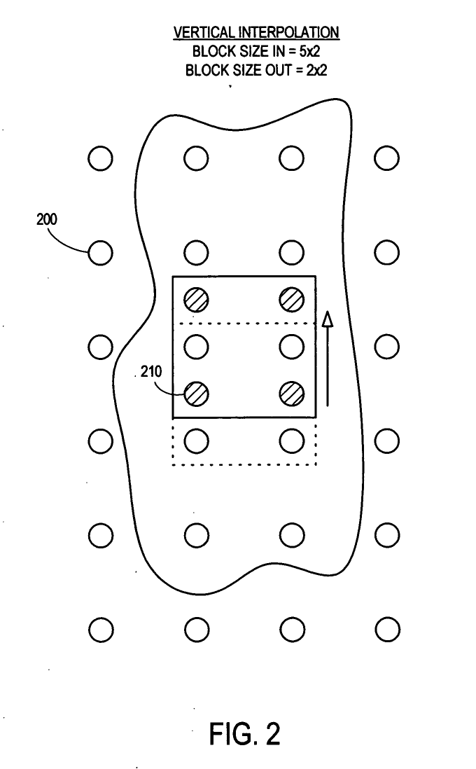

For example, FIG. 2 illustrates motion compensation associated with vertical movement. Although two-pixel by two-pixel blocks are illustrated in FIG. 2 for clarity, an actual implementation might use larger blocks, such as blocks having 8×8 or 16×16 pixels, etc. Moreover, although a particular motion compensation technique is described, other techniques could be used instead. In this example, the non-cross hatched circles 200 represent pixel locations, and the four circles 200 within the dotted-line block are the prior location of the block. Moreover, the motion vector indicates that the block has moved up in the frame. The dashed box indicates the block location being reconstructed (in the current frame), and the solid box indicates the position of the best match (e.g., associated with the motion vector in the reference frame).

Note that if the motion compensation vector indicates that the block has moved an integer number of pixels (e.g., three pixels downwards), the block can simply be placed in the new location. It may be, however, that a block has moved a non-integer number of pixels (e.g., 0.75 pixels upwards). In this case, the motion compensation unit 140 may use a filter to interpolate the current position of the block (e.g., in between the integer pixel locations). The cross-hatched circles 210 in FIG. 2 represent where the image information is actually located in such an example. The filters in this situation may operate on an array of data that is five pixels high and two pixels wide (e.g., a “5×2” block such as the ones encircled by a solid line in FIG. 2). The result of the operation will be a 2×2 array (representing the interpolated locations of the four pixels in the block).

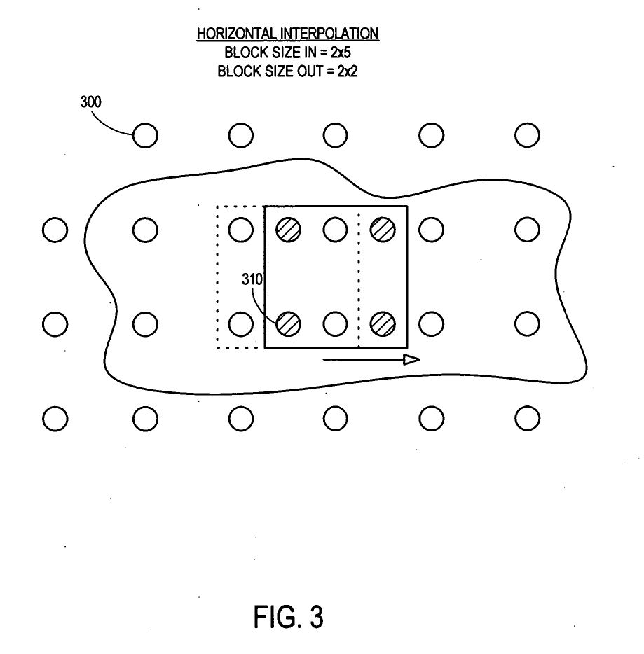

In addition to vertical interpolation, FIG. 3 illustrates motion compensation associated with horizontal movement. As before the non-cross hatched circles 300 represent integer pixel locations, and the four pixels inside the dotted-line block are the prior location of the block. In this example, the motion vector indicates that the block has moved a non-integer number of pixels to the right. As a result, the motion compensation unit 140 may use a filter to interpolate the current position of the block. Note that in this case, the filter may operate on a 2×5 block of information. That is, the block is two pixels high and five pixels wide (such as the ones encircled by a solid line in FIG. 3).

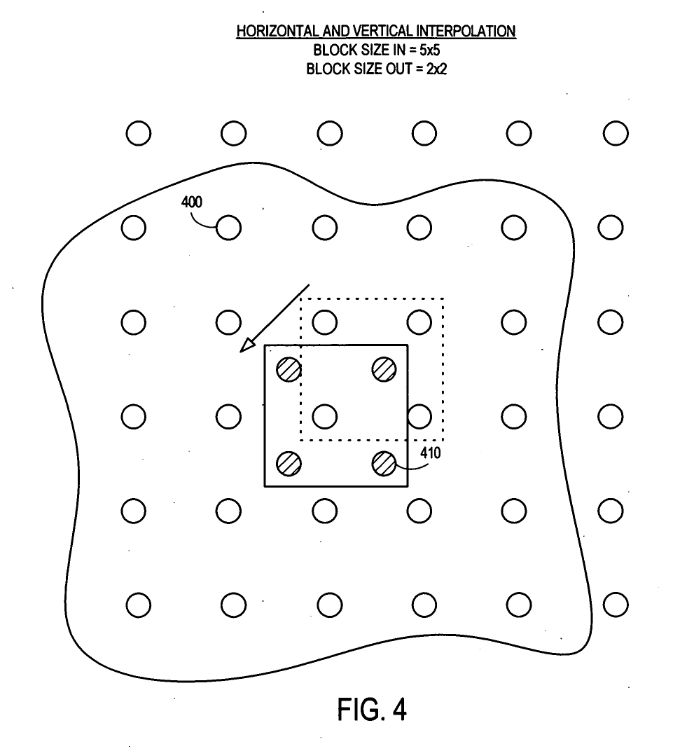

FIG. 4 illustrates motion compensation associated with diagonal movement. In particular, the block has moved a non-integer number of pixels to the left and a non-integer number of pixels down. In this example, the motion compensation unit 140 may use two filters to interpolate the current position of the block. Note that in this case, the filters may operate on a 5×5 block of information (such as the ones encircled by a solid line in FIG. 4).

Referring again to FIG. 1, after the motion compensation has been applied (e.g., using interpolation filters), a de-blocking filter 150 may receive the pel data (updated in accordance with the motion vector) and generate a final pel output to eventually be displayed to a viewer. The de-blocking filter 150 might, for example, smooth any visible artifacts that appear at the edges between blocks due to the effects of data lost during the encoding process.

Note that a number of different standards have been developed to encode and decode image information. For example, image information might be processed in accordance with the International Telecommunications Union (ITU) H.264 standard entitled “Advanced Video Coding (AVC) for Generic Audiovisual Services” (2003). As another approach, image information could be processed using the Society of Motion Picture and Television Engineers (SMPTE) Video Codec 1 (VC-1) standard or the MICROSOFT WINDOWS® Media Video Decoder (WMV9) standard. In other cases, image information might be processed using the Moving Pictures Expert Group (MPEG) Release Two (MPEG-2) 13818-2 or Release Four (MPEG-4) 14496 (1999/2002) standards published by the International Standards Organization (ISO) and the International Electrotechnical Commission (IEC).

Although all of these standards use some form of motion compensation, the particular methods used to encode and/or decode the motion compensation information are different. For example, the block size, the number of interpolation filter taps, the values associated with interpolation filter taps, and/or the interpolation context size may be different. As another example, one standard might require that horizontal interpolation be performed before vertical interpolation while another standard requires that horizontal interpolation be performed after vertical interpolation. As still another example, the ways in which intermediate values are combined and/or rounded may be different.

Different motion compensation units 140 could be designed to support different video compression standards. For example, a first circuit could be designed such that a horizontal interpolation filter provides signals to a vertical compensation unit while a second circuit is designed the other way around. Such an approach, however, may be costly and impractical (e.g., it may be difficult to design a system that supports a significant number of video compression standards).

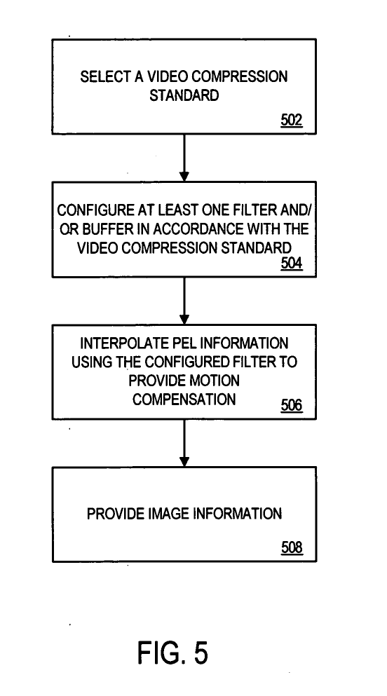

FIG. 5 is a flow chart of a method according to some embodiments. The method might be associated with, for example, the motion compensation unit 140 described with respect to FIG. 1. The flow chart does not necessarily imply a fixed order to the actions, and embodiments may be performed in any order that is practicable. Note that any of the methods described herein may be performed by hardware, software (including. microcode), firmware, or any combination of these approaches. For example, a storage medium may store thereon instructions that when executed by a machine result in performance according to any of the embodiments described herein.

At 502, an video compression standard is selected, and at least one filter is configured in accordance with the selected image processing technique at 504. According to some embodiments, one or more buffers and/or buffer controllers may also be configured. For example, a unit might be configured such that “1.5” will be rounded to “1.0” when one standard is selected or to “2.0” when another standard is selected. Note that these actions might be performed, for example, by a system designer and/or a digital media processor during an initialization process.

At 506, pel information is interpolated via the configured filter to provide motion compensation. For example, the pel information might be vertically interpolated by a second filter after being horizontally interpolated by a first filter when one standard is selected (and horizontally interpolated by the second filter after being vertically interpolated by the first filter when a different standard is selected). The image information may then be combined with reside from an inverse discrete cosine transform unit to generate a final pixel that can be provided (e.g., to a viewer).

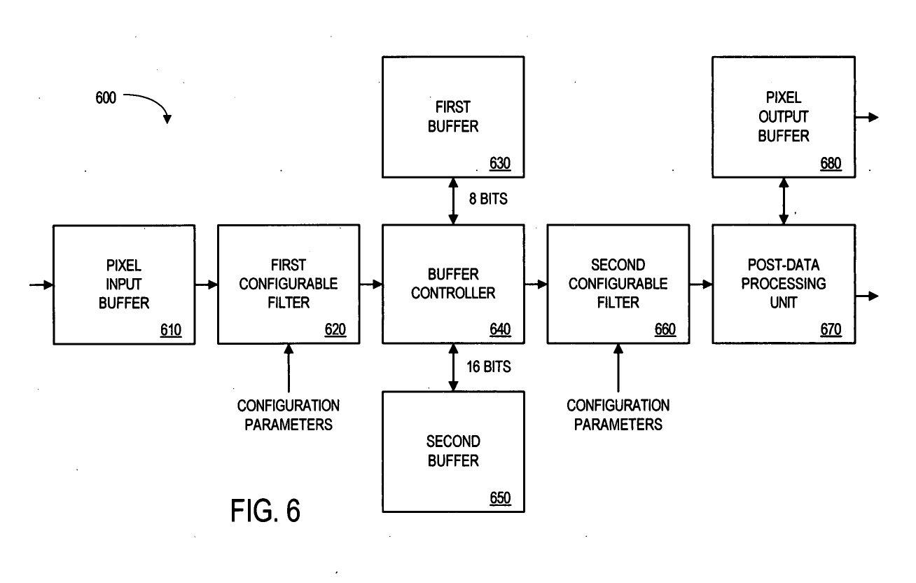

FIG. 6 is a block diagram of a motion compensation unit 600 according to some embodiments. The unit 600 includes a pixel input buffer 610 that may store input pixel information (e.g., reference block data). The pixel input buffer 610 may be, for example, a circular two-dimensional (2D) buffer. According to some embodiments, the size of the pixel input buffer 610 is twice as large as a single reference block. In this way, data associated with the next reference block may be loaded into buffer 610 while a current reference block is being processed. Moreover, according to some embodiments the buffer 610 allows for sharing between consecutive blocks when allowed by the motion vector.

The input pixel information is provided from the pixel input buffer 610 to a first configurable filter 620. The filter 620 may, for example, be a multi-tap interpolation filter adapted to perform either horizontal or vertical interpolation. Moreover, the filter 620 may be configurable such that one or more configuration parameters can be used to provide a bypass operation (e.g., the filter 620 might not perform any function on the data). According to some embodiments, the filter 620 is a six-tap filter that can also be configured to operate in accordance with the following equation:
Qi=(C0*P0+C1*P1+C2*P2+C3*P3+C4*P4+C5*P5 +2^{FLT1}^{_{—}}^{SHFT1}−RND1)>>FLT1_SHFT1
where each Pi is a raw pixel value, Ci is a filter tap coefficient (e.g., selected from a bank of coefficients during a configuration in accordance with an video compression standard), FLT_SHFT1 is a configuration parameter to shift information, RND1 is a configuration parameter associated with a rounding function, and Qi represents an un-scaled filter output. The filter 620 might also be configurable to operate in accordance with the following equation:
SQi=CLIP8(C0*P0+C1*P1+C2*P2+C3*P3+C4*P4+C5*P5+2^{SHFT1}−RND1)>>SHFT1
where SHFT1 is a configuration parameter to shift information, RND1 is a configuration parameter associated with a rounding function, CLIP8 indicates that values below zero will be set to zero and values above 255 will be set to 255, and SQi represents a scaled filter output.

The raw, scaled, or un-scaled output from the first configurable filter 620 might then be stored in a first buffer 630. The buffer 630 might comprise, for example, an eight-bit wide Random Access Memory (RAM) unit that stores intermediate results for the motion compensation unit 600. According to some embodiments, a second buffer 650 may also be provided and the operation of the buffers 630, 650 may be controlled by a buffer controller 640. The second buffer 650 might be, for example, a sixteen-bit wide RAM unit. According to some embodiments, one buffer stores raw or scaled filtered pixels when the other buffer stores full-precision intermediate results from the first configurable filter 620.

Information from the buffers 630, 650 may then be provided to a second configurable filter 660. According to some embodiments, the buffer controller 640 and/or the buffers 630, 650 are configurable such that transposed data may be provided to the second configurable filter 660 if desired. Note that information from either of the two buffers 630, 650 might be combined with an output of the second configurable filter 660.

The second configurable filter 660 may then interpolate the received data. For example, when the first filter 620 was configured to perform a horizontal interpolation, the second filter 660 might be configured to perform a vertical interpolation (or the other way around). According to some embodiments, the second configurable filter 660 may provide a bypass operation (in which case the data remains unchanged). According to some embodiments, the filter 660 is a six-tap filter that can be configured to operate in accordance with the following equation:
Yi=(C0*X0+X1*P1+X2*P2+X3*P3+X4*P4+X5*P5)
where each Xi is a value from one of the buffers 630, 650 (and the buffer might be selectable based on the configuration parameters), Ci is a filter tap coefficient (e.g., selected from a bank of coefficients during a configuration in accordance with an video compression standard), and Yi represents an un-scaled filter output. The filter 660 might also be configurable to operate in accordance with the following equation:
SYi=CLIP8(C0*X0+C1*X1+C2*X2+C3*X3+C4*X4+C5*X5+2^{SHF2}−RND2)>>SHFT2
where SHFT2 is a configuration parameter to shift information, RND2 is a configuration parameter associated with a rounding function, CLIP8 indicates that values below zero will be set to zero and values above 255 will be set to 255, and SYi represents a scaled filter output.

Note that any of the information stored in the two buffers 630, 650 might be combined with an output of the second configurable filter 660. Such an ability may, for example, facilitate a conversion of a two-dimensional filter to do a three-dimensional filtering operation (e.g., as might be the case with respect to H.264 operations).

The second configurable filter 660 provides output pixel information to a post-data processing unit 670 which may store the information in a pixel output buffer 680. According to some embodiments, the post-data processing unit 670 may be configured to combine the data from the second configurable filter 660 with information from the pixel output buffer 680 (e.g., to support H.264 interpolation). Note that the motion compensation unit 600 might be able to simultaneously perform operations associated with multiple blocks (e.g., the pipe-line design might let the first filter 620 perform an interpolation for one block while the second filter 660 is performing an interpolation for another block).

Thus, the motion compensation unit 600 may be configurable to combine: (i) the output of the first configurable filter 620 with raw pixel information, (ii) the output of the second configurable filter 660 with raw pixel information, (iii) the output of the second configurable filter 660 with scaled pixels from the first configurable filter, (iv) the output of the second configurable filter 660 with un-scaled pixels from the first configurable filter, or (v) combining information from one of the buffers 630, 650 with the output of the second configurable filter 660. Although a few approaches have been described, the motion compensation unit 600 might be configured in any of a number of different ways. For example, information from one source might be address offset before being combined with information from another source. For example, when combining pels from the first buffer 630 and/or the second buffer 650 with an output of the second configurable filter 660, an address offset may allow the second row of pels from the first buffer 630 to be combined with the first row of output from the second configurable filter 660. Similarly, the second column of pels from the first buffer 630 might be combined with the first column of output from the second configurable filter 660 (e.g., in connection with an H.264 operation).

As a result, an efficient, generic motion compensation unit 600 may be provided to support various video compression standards. For example, the unit 600 could be configured to support different block sizes, numbers of filter taps, and/or filter coefficients. Similarly, either horizontal or vertical interpolations could be performed first depending on the standard. Note that such a unit 600 might be associated with a hardware accelerator, an Application Specific Integrated Circuit (ASIC) device, and/or an INTEL®-Architecture (IA) based device.

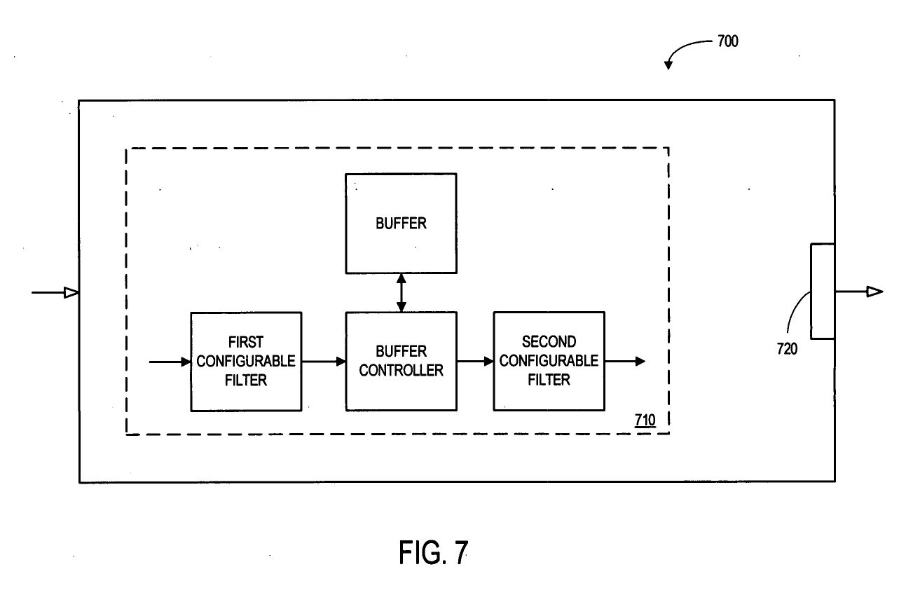

FIG. 7 is a block diagram of a system 700 according to some embodiments. The system 700 might be associated with, for example, a PC, a set-top box, a media center, a game system, a digital video recorder, a video receiver, or a television such as a High Definition Television (HDTV) device. Moreover, the system 700 may receive image information and process the information in accordance with one or more of the MPEG-2 standard, the MPEG-4 standard, the H.264 standard, the VC-1 standard, or the WMV9 standard.

The system 700 includes a motion compensation unit 710 that operates in accordance with any of the embodiments described herein. For example, the motion compensation unit 710 might configure a first and second multi-tap filter in accordance with a first image processing standard and calculate motion compensation values via the configured filters in accordance with that standard. The motion compensation unit 710 might instead configure the filters in accordance with a second image processing standard and calculate motion compensation values via the configured filters in accordance with that standard. The system 700 may also include a digital output port to provide a signal associated with output image information to an external device (e.g., to an HDTV device).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although a particular design for a motion compensation unit has been described herein, other designs may be used according to other embodiments. Similarly, although embodiments have been described with respect to a decoder, note that some embodiments may also be associated with an encoder. Moreover, although particular video compression standards have been used as examples, the motion compensation unit might be configurable to support any other standard.

The several embodiments described herein are solely for the purpose of illustration. Persons skilled in the art will recognize from this description other embodiments may be practiced with modifications and alterations limited only by the claims.

What is claimed is:

1. An apparatus, comprising:
a first filter to receive input pixel information and to provide a first output;
a buffer to store the first output; and
a second filter to receive information from the buffer and to provide output pixel information, wherein at least one of the first or second filters are configurable to support motion compensation for a plurality of video compression standards.

2. The apparatus of claim 1, wherein at least one of the first or second filter is configurable to perform either: (i) vertical pixel interpolation, or (ii) horizontal pixel interpolation.

3. The apparatus of claim 1, wherein at least one of the first or second filter is configurable to perform at least one of: (i) a bypass operation, (ii) multi-tap coefficient filtering, (iii) un-scaled filtering, (iv) scaled filtering, or (v) an address offset operation.

4. The apparatus of claim 1, wherein the buffer comprises a first random access memory unit and further comprising:
a second random access memory unit; and
a buffer controller configurable to provide to the second filter at least one of: (i) data from the first random access memory, (ii) data from the second random access memory, or (iii) data associated with both the first and second random access memories.

5. The apparatus of claim 1, further comprising:
a circular 2D pixel input buffer to store the pixel information and to provide the pixel information to the first filter.

6. The apparatus of claim 1, further comprising:
a configurable post-data processing unit to receive the output pixel information from the second filter.

7. The apparatus of claim 6, further comprising:
a pixel output buffer to store data from the post-data processing unit, wherein the post-data processing unit may combine information in the pixel output buffer with the output pixel information from the second filter.

8. The apparatus of claim 1, wherein at least one of the video compression standards is associated with: (i) the MPEG-2 standard, (ii) the MPEG-4 standard, (iii) the H.264 standard, (iv) the video codec-1 standard, or (v) a media video decoder standard.

9. The apparatus of claim 1, wherein the filters are associated with a digital media processor.

10. A method, comprising:
configuring at least one of a first and second filter in accordance with an image processing technique; and
interpolating pel information via the configured filters to provide motion compensation, wherein the filters are further configurable to provide motion compensation in accordance with another image processing technique.

11. The method of claim 10, wherein said configuring is performed during an initialization process.

12. The method of claim 10, further comprising:
selecting the image processing technique from a set of potential image processing techniques.

13. The method of claim 10, further comprising:
configuring a buffer controller in accordance with the image processing technique.

14. The method of claim 10, wherein: (i) said configuring in accordance with a first image processing technique results in the pel information being vertically interpolated by the second filter after being horizontally interpolated by the first filter, and (ii) said configuring in accordance with a second image processing technique results in the pel information being horizontally interpolated by the second filter after being vertically interpolated by the first filter.

15. The method of claim 10, wherein said configuring is associated with at least one of: (i) a bypass mode, (ii) a multi-tap coefficient filtering mode, (iii) an un-scaled filtering mode, (iv) a scaled filtering mode, (v) or an address offset mode.

16. An article, comprising:
a storage medium having stored thereon instructions that when executed by a machine result in the following:
configuring a first multi-tap filter and a second multi-tap filter in accordance with a first image processing standard;
calculating motion compensation values via the configured filters in accordance with the first image processing standard;
configuring the filters in accordance with a second image processing standard; and
calculating motion compensation values via the configured filters in accordance with the second image processing standard.

17. The article of claim 16, wherein at least one of the first and second image processing standard is associated with: (i) the MPEG-2 standard, (ii) the MPEG-4 standard, (iii) the H.264 standard, (iv) the video codec-1 standard, or (v) a media video decoder standard.

18. The article of claim 16, further comprising:
receiving a digital video signal, wherein said calculating is based on information associated with the received signal; and
providing image information based on the motion compensation values.

19. A system, comprising:
a hardware motion compensation unit, including:
a first filter to receive input image information and to provide a first output, and
a second filter to receive information associated with the first output and to provide output image information, wherein at least one of the first or second filters are configurable to support motion compensation calculations associated with multiple video compression standards; and
a digital output port to provide a signal associated with the output image information to an external device.

20. The system of claim 19, further comprising:
a configurable intermediate buffer to store at least one of the first output or the received input image information.

21. The system of claim 19, wherein said system is associated with at least one of: (i) a personal computer, (ii) a set-top box, (iii) a media center, (iv) a game system, (v) a digital video recorder, (vi) a video receiver, or (vii) a television.
